(19) United States
(12) Patent Application Publication
(10) Pub. No.: US 2020/0104678 A1
(43) Pub. Date: Apr. 2, 2020

(54) TRAINING OPTIMIZER NEURAL NETWORKS

(71) Applicant: Google LLC, Mountain View, CA (US)

(72) Inventors: Jeremy Nixon, Palo Alto, CA (US); Jascha Narain Sohl-Dickstein, San Francisco, CA (US); Luke Shekerjian Metz, Mountain View, CA (US); Christian Daniel Freeman, San Francisco, CA (US); Niruban Maheswaranathan, Mountain View, CA (US)

(21) Appl. No.: 16/586,220

(22) Filed: Sep. 27, 2019

Related U.S. Application Data
(60) Provisional application No. 62/737,871, filed on Sep. 27, 2018.

(51) Int. Cl. G06N 3/04; G06N 3/08

(52) U.S. Cl. CPC G06N 3/0454; G06N 3/084

(57) ABSTRACT

A computer-implemented method for training an optimizer neural network having optimizer parameters is described. The optimizer neural network is configured to generate an output that defines updated values of target parameters of a target neural network in a set of target neural networks during training of the target neural network to perform one or more neural network tasks. The optimizer neural network is associated with an outer loss function that measures how well the optimizer neural network generates updated values of target parameters for the target neural network. The method comprises: initializing current values of the optimizer parameters; repeatedly performing the following operations to determine trained values of the optimizer parameters: generating perturbed values of the optimizer parameters by applying a perturbation to the current values of the optimizer parameters, training an instance of target neural network to perform a neural network task associated with the instance of target neural network by updating values of parameters of the instance of target neural network in accordance with the perturbed values of the optimizer parameters, evaluating a performance of the trained instance of target neural network on the neural network task associated with the instance of target neural network to determine one or more performance metrics for the trained instance of the target neural network on the neural network task, determining, using the one or more performance metrics for the trained instances of target neural network, a gradient estimate of the outer loss function associated with the optimizer neural network, and adjusting the current values of the optimizer parameters of the optimizer neural network based on the gradient estimate of the outer loss function associated with the optimizer neural network.

### CROSS-REFERENCE TO RELATED APPLICATION

This application claims priority to U.S. Provisional Application Ser. No. 62/737,871, filed on Sep. 27, 2018. The disclosure of the prior application is considered part of and is incorporated by reference in the disclosure of this application.

### BACKGROUND

This specification relates to training machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that trains an optimizer neural network to determine optimizer parameters that define an update rule for training a target neural network to perform one or more neural network tasks.

Particular embodiments of the subject matter described in this specification can be implemented so as to realize one or more of the following advantages. Existing gradient-based optimization methods for training a target neural network involve analysis and development of hand-designed optimizers that are applicable for a wide variety of tasks or are tuned to specific tasks via hyper-parameter search. However, hand-designed optimizers require manually adjusting step sizes during training and therefore are time-consuming and often result in unsatisfied trained values for the target neural network, i.e., the trained neural network may have low performance on a validation set or during inference. Customized optimizers, on the other hand, can overcome the drawbacks of hand-designed optimizers by learning a function to perform optimization, targeted to particular tasks of interest. In this way, the customized optimizers may learn task specific network structures, enabling significant performance improvements over the more general, hand-designed optimizers. The subject matter described in this specification is directed to a system and method for training a customized optimizer, i.e., an optimizer neural network, to determine updated values of parameters of a target neural network during training of the target neural network on one or more machine learning tasks.

To train the optimizer neural network, the system aims to compute derivatives of an outer loss function with respect to optimizer parameters of the optimizer neural network. Doing this requires unrolling the optimization process. That is, the system can form an unrolled computational graph that includes iteratively applying an optimizer (u) to optimize parameters (w) of a target neural network. Computing gradients for the optimizer parameters involves backpropagating the outer loss function through this unrolled computational graph. This is a costly operation, as the entire inner-optimization problem must be unrolled in order to get a single outer-gradient. To reduce the computation costs, the system described in this specification is configured to partition the unrolled computation into separate segments, known as truncated backpropagation, thus allowing the computation of multiple outer-gradients over shorter segments.

In some cases, training the optimizer neural network using truncated backpropagation through an unrolled optimization process may result in gradients that are either strongly biased (for short truncations) or have exploding norm (for long truncations). The techniques described herein address the strongly biased or exploding gradients challenge by dynamically reweighting the contribution of reparameterization gradient and log-derivative gradient in a combined gradient estimate of the objective function (also referred to as an outer loss function) of the optimizer neural network. Therefore, the techniques can speed-up the training time to find parameters of the optimizer neural network. Further, by using a smoother version of the objective function of the optimizer neural network during training, and by updating the value of parameters of the optimizer neural network based on the combined gradient estimate of the smoother version, the techniques improves the stability of trained values of parameters of the optimizer neural network, leading to faster training time.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an architecture of an example neural network system for training an optimizer neural network.

FIG. 2 is a flow diagram of an example process for generating a gradient estimate of an outer loss function associated with the optimizer neural network.

FIG. 3 is a flow diagram of an example process for training the optimizer neural network.

Like reference numbers and designations in the various drawings indicate like elements.

### DETAILED DESCRIPTION

This specification describes a neural network system implemented as computer programs on one or more computers in one or more locations that trains an optimizer neural network to determine optimizer parameters that define an optimized update rule for updating values of target parameters of a target neural network during training of the target neural network.

The target neural network can be configured to perform one or more of any appropriate target neural network tasks, i.e., to receive any kind of digital data input and to generate any kind of score, classification, or regression output based on the input.

For example, if the inputs to a target neural network are images or features that have been extracted from images, the output generated by the target neural network for a given image may be scores for each of a set of object categories, with each score representing an estimated likelihood that the image contains an image of an object belonging to the category.

As another example, if the inputs to the target neural network are Internet resources (e.g., web pages), documents, or portions of documents or features extracted from Internet resources, documents, or portions of documents, the output generated by the neural network for a given Internet resource, document, or portion of a document may be a score for each of a set of topics, with each score representing an estimated likelihood that the Internet resource, document, or document portion is about the topic.

As another example, if the inputs to the target neural network are features of an impression context for a particular advertisement, the output generated by the target neural network may be a score that represents an estimated likelihood that the particular advertisement will be clicked on.

As another example, if the inputs to the target neural network are features of a personalized recommendation for a user, e.g., features characterizing the context for the recommendation, e.g., features characterizing previous actions taken by the user, the output generated by the target neural network may be a score for each of a set of content items, with each score representing an estimated likelihood that the user will respond favorably to being recommended the content item.

As another example, if the input to the target neural network is a sequence of text in one language, the output generated by the neural network may be a score for each of a set of pieces of text in another language, with each score representing an estimated likelihood that the piece of text in the other language is a proper translation of the input text into the other language.

As another example, if the input to the target neural network is a sequence representing a spoken utterance, the output generated by the neural network may be a score for each of a set of pieces of text, each score representing an estimated likelihood that the piece of text is the correct transcript for the utterance.

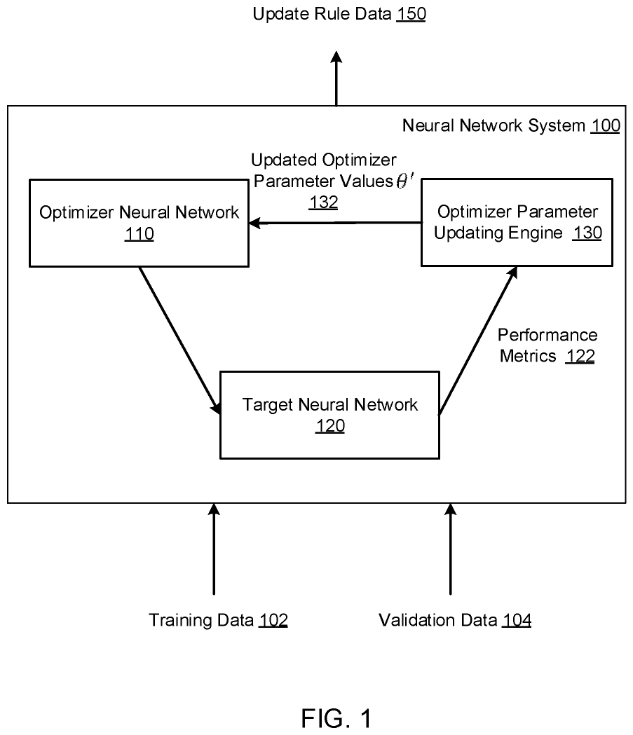

FIG. 1 shows an example neural network system 100. The system 100 is an example of a system implemented as computer programs on one or more computers in one or more locations, in which the systems, components, and techniques described below can be implemented.

The neural network system 100 is a system that receives a request to determine an optimized update rule for training a target neural network (e.g., the target neural network 120) to perform one or more respective target tasks. An update rule, denoted as u(⋅), is a parameterized function that defines how to map the target parameters of a target neural network at iteration t of the training of the target neural network to iteration t+1 of the training.

To determine the optimized update rule, the system 100 trains an optimizer neural network 110 to determine trained values of optimizer parameters (θ′) of the optimizer neural network 110. The trained values of the optimizer parameters of the optimizer neural network 110 define the optimized update rule, denoted as u(⋅; θ′), for updating values of target parameters (w) during a training of the target neural network 120. The optimized update rule can be applied to current values of target parameters at a given time step to obtain updated values of target parameters at a next time step during the training of the target neural network 120.

Generally, the optimizer neural network 110 is a fully connected neural network. For example, the optimizer neural network 110 can be a small, fast to compute, fully connected neural network with one hidden layer, e.g., a feed forward multilayer perceptron (MLP) containing 32 hidden ReLU units.

Training the optimizer neural network 110 is considered as solving a bi-level optimization problem with inner and outer levels. The inner level includes optimizing target parameters (w) of a target loss function l(w) by the repeated application of an update rule to the target parameters (w). The target loss function l(w) represents performance of the target neural network 120 on the target task and can be measured over either the training data 102 or the validation data 104.

As discussed above, an update rule, denoted as u(⋅) is a parameterized function that defines how to map the parameters of the target neural network 120 at iteration t of the training to iteration t+1 of the training as follows:

w^{(t+1)}=u(w^{(t)};θ), (1)

where w^{(t)} and w^{(t+1)} denotes parameters of the target neural network 120 at time step t and t+1 respectively, and θ represents the optimizer parameters of the optimizer neural network 110.

The optimizer neural network 110 is associated with an outer loss function L(θ) that measures performance of the optimizer neural network 110 given parameter values θ. For example, the outer loss function measures how well the target neural network 110 performs after being trained using an update rule defined by θ. At the outer level, the optimizer parameters θ are updated to optimize the outer loss function L(θ). The outer loss function L(θ) may be an average value of the target loss function l(⋅) measured over either training or validation data.

To train the optimizer neural network 110, the system 100 samples a dataset from a set of datasets. Each dataset is associated with a respective neural network task, i.e., each dataset can be used for training the target neural network 120 to perform the respective neural network task. Each dataset includes training data and validation data. For example, the system 100 samples a dataset D from the set of datasets T. The system 100 then receives the dataset D that includes training data 102 for training an instance of the target neural network 120 to perform a target task and a validation set 104 for evaluating the performance of the instance of the target neural network 120 on the target task. The system 100 may initialize values of the optimizer parameters θ of the optimizer neural network 110 and inner parameter w of the target neural network 120, e.g., randomly.

Generally, the training data 102 and the validation set 104 both include a set of neural network inputs and, for each network input, a respective target output that should be generated by the target neural network 120 to perform the target task. For example, a larger set of training data may have been randomly partitioned to generate the training data 102 and the validation set 104.

The system 100 may receive the training data 102 and the validation set 104 in any of a variety of ways. For example, the system 100 may receive training data as an upload from a remote user of the system over a data communication network, e.g., using an application programming interface (API) made available by the system 100, and randomly divide the uploaded data into the training data 102 and the validation set 104. As another example, the system 100 may receive an input from a user specifying which data that is already maintained by the system 100 should be used for training the neural network, and then divide the specified data into the training data 102 and the validation set 104.

To train the optimizer neural network 110, the system 100 aims to compute derivatives of the outer loss function L with respect to the optimizer parameters θ. Doing this requires unrolling the optimization process. That is, the system 100 can form an unrolled computational graph that includes iteratively applying an optimizer (u) to optimize the target parameters (w) of the target neural network. Computing gradients for the optimizer parameters involves backpropagating the outer loss function through this unrolled computational graph. This is a costly operation, as the entire inner-optimization problem must be unrolled in order to compute a single outer-gradient. To reduce the computation costs, the system 100 can be configured to partition the unrolled computation into separate segments, known as truncated backpropagation, thus allowing the computation of multiple outer-gradients over shorter segments. That is, rather than compute the full gradient from iteration t=0 to t=T, the system 100 can be configured to compute gradients in windows from t=a to t=a+τ. The gradients from these segments (or truncations) can be used to update θ without unrolling all T iterations, dramatically decreasing the computation needed for each update to θ.

For each truncation τ, the system 100 repeatedly performs the following operations.

First, the system 100 samples a perturbation value e˜N(0, σ²I), where N(0, σ²I) is a Gaussian distribution with mean 0, covariance σ, and identity matrix I.

The system 100 then generates perturbed values of the optimizer parameters by applying a perturbation to the current values of the optimizer parameters. In particular, the system 100 generates (i) a positively-perturbed value of the optimizer parameters, denoted as θ+e, and (ii) a negatively-perturbed value of the optimizer parameters, denoted as θ−e.

The system 100 then trains an instance of the target neural network 120 to perform a neural network task associated with the instance of target neural network 120 by updating values of target parameters of the instance of target neural network 120 in accordance with the perturbed values of the optimizer parameters. The system 100 samples a number of steps per truncation, k, for updating the values of target parameters of the target neural network 120 based on the current outer training iteration, where k is a positive integer.

In particular, the system 100 computes a positive sequence of updated parameter values of the instance of target neural network 120 starting from w^{(t)} by repeatedly applying (fork steps) an update rule u(⋅; θ+e) to w^{(t)}. The positive sequence of updated parameter values can be denoted as {w^{(t+1)}^{⁺}, w^{(t+2)}^{⁺}, . . . , w^{(t+k)}^{⁺}}. The system 100 computes a negative sequence of updated parameter values of the instance of target neural network 120 starting from w^{(t)} by repeatedly applying (for k steps) an update rule u(⋅, θ−e) to w^{(t)}. The negative sequence of updated parameter values can be denoted as {w^{(t+1)}^{^{−}}, w^{(t+2)}^{^{−}}, . . . , w^{(t+k)}^{^{−}}}.

The system 100 determines one or more performance metrics that represent the performance of the trained instance of the target neural network 120 on the target task.

In particular, the system 100 computes a pair of perturbed values (L⁺, L⁻) for the outer loss function with both a positive and negative antithetic sample (L⁺,L⁻) using the two sequences of w from time step t to time steps t+k using either the training data 102 or the validation data 104.

For example, the outer loss function L(θ) may be an average value of the target loss function l(⋅) measured over either training or validation data. In this example, the system 100 may compute a positively perturbed value for the outer loss function L⁺ by computing an average value of the target loss functions computed based on the positive sequence of updated target parameter values w of the instance of target neural network 120. The system 100 may compute a negatively perturbed value for the outer loss function L⁻ by computing an average value of the target loss functions computed based on the negative sequence of updated target parameter values w of the instance of target neural network 120.

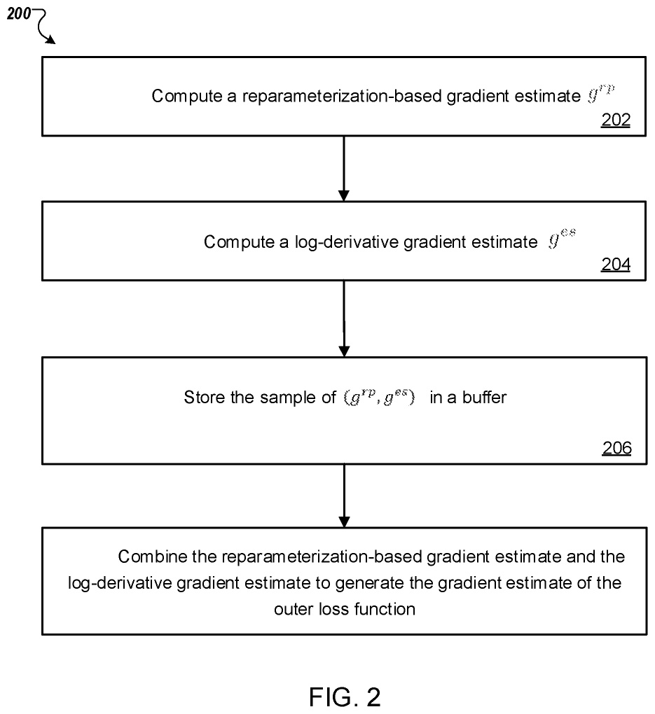

Based on the performance metrics (L⁺, L⁻) that represent performance of the trained instance of the target neural network 120, the system 100 generates, using an optimizer parameter updating engine 130, (i) a sample of a reparameterization-based gradient estimate g^{rp} of the outer loss function, and (ii) a sample of a log-derivative gradient estimate g^{es} of the outer loss function. A process for computing a sample of a reparameterization-based gradient estimate g^{rp} and a sample of a log-derivative gradient estimate g^{es} of the outer loss function is described in more detail below with reference to FIG. 2.

The optimizer parameter updating engine 130 stores the sample of (g^{rp}, g^{es}) in a buffer until a batch of samples of gradients is ready, i.e., until the above process has been repeatedly performed for all truncations.

At the end of the current truncation, the system 100 assigns the current target parameters w from one of the two sequences with the inner parameter values from the end of the truncation (w^{t+k}). In some implementations, the system 100 assigns the current target parameters w with the positive parameter values w^{(t+k)}^{⁺} from the end of the truncation. In some other implementations, the system 100 assigns the current target parameters w with the negative parameter values w^{(t+k)}^{^{−}} from the end of the truncation. In some other implementations, the system 100 randomly selects one of the positive parameter values w^{(t+k)}^{⁺} or the negative parameter values w^{(t+k)}^{^{−}}, and assigns the current target parameters w with the selected parameter values.

The system 100 repeatedly performs the above process for all truncations. When the last truncation iteration is completed and the batch of samples of gradients is ready, the engine 130 computes a combined gradient estimate for the outer loss function by combining all of the samples of (g^{rp} g^{es}) that have been generated.

The process for determining the combined gradient estimate of the outer loss function is described in more detail below with reference to FIG. 2.

After the combined gradient estimate of the outer loss function is determined, the optimizer parameter updating engine 130 updates the current values of the optimizer parameters of the optimizer neural network 110 based on the combined gradient estimate, e.g., by backpropagating the combined gradient estimate of the outer loss function.

In some implementations, a smoother version of the outer loss function of the optimizer neural network 110 can be used in place of the outer loss function L(θ) during training. The smoother version of the outer loss function can have the following form:

[symbol]

(θ)= [symbol] _{\tilde{θ}˜N(θ,σ}_{²}_{I}[L(\tilde{θ})], (2)

where σ² is a fixed variance that determines the degree of smoothing. The optimizer parameter updating engine 130 can update the values of optimizer parameters of the optimizer neural network by computing a combined gradient estimate of the smoother version [symbol] (θ) instead of the version L(θ) as described above, and then backpropagating the combined gradient estimate of the smoother version. The use of the smoother version [symbol] (θ) can improve the stability of trained values of optimizer parameters of the optimizer neural network 110, leading to faster training time.

The system 100 can sample another dataset (including new training data and new validation data) from the set of datasets T and repeat the above bi-level training process to obtain more samples of (g^{rp}, g^{es}) for updating the values of the optimizer parameters. By repeatedly updating the values of the optimizer parameters in this manner, the system 100 can train the optimizer neural network 110 to obtain optimizer parameters that define update rules that, when used during training, result in target neural networks that have increased performance on respective target neural network tasks, i.e., to maximize the expected accuracy on validation data 104 of the trained target neural networks.

In some implementations, to speed up the training of the optimizer neural network 110, the system 100 trains the optimizer neural network 110 in a distributed manner. That is, the system 100 obtains multiple training datasets in parallel distributed across multiple different worker computing units that are configured so that they can perform the above bi-level training process independently of each other. In some implementations, only partial independence of operation is achieved, for example, because computing units share some resources. A computing unit may be, e.g., a computer, a core within a computer having multiple cores, or other hardware or software within a computer capable of independently performing the computation required to evaluate the measure of performance of target neural networks and to compute gradients of the outer loss function.

Once the optimizer neural network 110 has been trained, the system 100 can output update rule data 150 that specifies the optimized update rule u(⋅;θ′), where θ′ is the updated values of optimizer parameters 132 obtained after the training. For example, the neural network system 100 can output the update rule data 150 to the user that submitted the training data.

In some implementations, instead of or in addition to outputting the update rule data 150, the system 100 trains a particular neural network using the optimized update rule, e.g., either from scratch or to fine-tune the parameter values generated as a result of training the instance of the target neural network 120 using the optimized update rule, and then uses the trained particular neural network to process requests received by users, e.g., through the API provided by the system 100. That is, the system 100 can receive inputs to be processed, use the trained particular neural network to process the inputs, and provide the outputs generated by the trained particular neural network or data derived from the generated outputs in response to the received inputs.

FIG. 2 is a flow diagram of an example process 200 for generating the gradient estimate of the outer loss function associated with the optimizer neural network 110. For convenience, the process 200 will be described as being performed by a system of one or more computers located in one or more locations. For example, a neural network system, e.g., the neural network system 100 of FIG. 1, appropriately programmed in accordance with this specification, can perform the process 200.

At step 202, the system computes a sample of a reparameterization-based gradient estimate of the outer loss function based on the performance metrics (L⁺, L) of the trained instance of the target neural network as follows:

g^{rp}=∇_{θ}½(L⁺,L⁻), (2)

where ∇_{θ}½(L⁺,L⁻) denotes a gradient of ½(L⁺+L⁻) with respect to optimizer parameters θ.

At step 204, the system computes a sample of a log-derivative gradient estimate of the outer loss function as follows:

g^{es}=½(L⁺−L⁻)∇_{θ} log(N(e;θ,σ²I)), (3)

where N(e; θ, σ²I) is the probability density of the sampled perturbation e.

At step 206, the system stores the sample of (g^{rp}, g^{es}) in a buffer until a batch of samples is ready.

At step 208, when the last truncation iteration is completed and the batch of samples is ready, the system computes a gradient estimate for the outer loss function by combining the samples of (g^{rp}, g^{es}) that have been generated by using inverse variance weighting as follows:

$${g}_{merged} = \frac{\overline{{g}_{rp}} {σ}_{rp}^{- 2} + \overline{{g}_{es}} {σ}_{es}^{- 2}}{{σ}_{rp}^{- 2} + {σ}_{es}^{- 2}} , \qquad ( 4 )$$

where g̅ᵣ̅ₚ̅ and σ̅ᵣ̅ₚ̅ are empirical mean and empirical variance of the samples of a reparameterization-based gradient estimate of the outer loss function, respectively; and where g̅ₑ̅ₛ̅ and σ̅ₑ̅ₛ̅ are empirical mean and empirical variance of the samples of a log-derivative gradient estimate of the outer loss function, respectively.

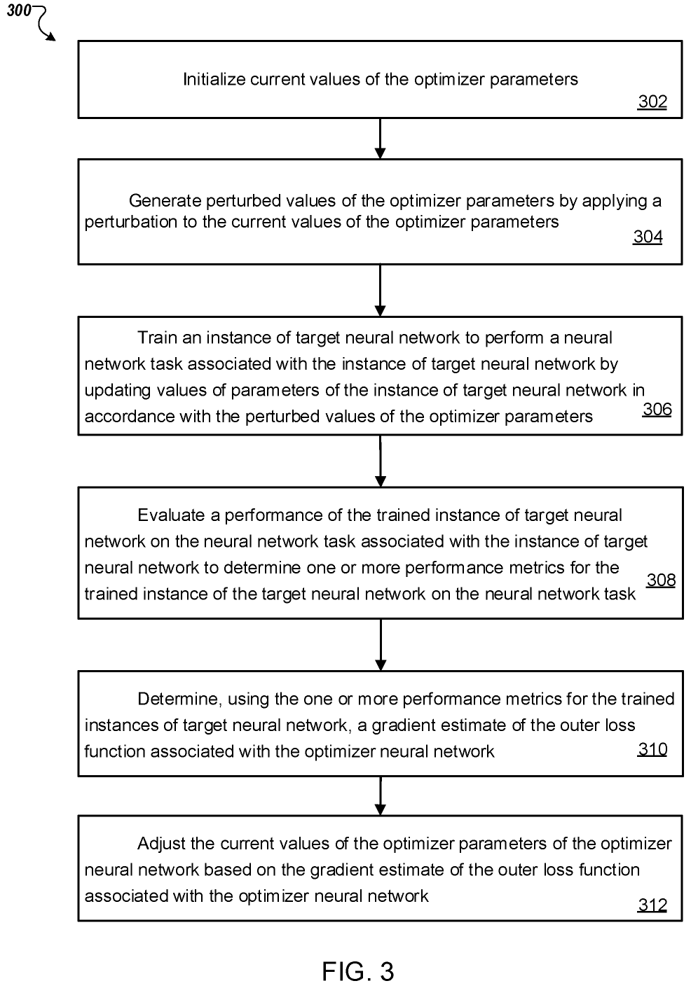

FIG. 3 is a flow diagram of an example process 300 for training the optimizer neural network. For convenience, the process 300 will be described as being performed by a system of one or more computers located in one or more locations. For example, a neural network system, e.g., the neural network system 100 of FIG. 1, appropriately programmed in accordance with this specification, can perform the process 300. The optimizer neural network is configured to generate an output that defines updated values of target parameters of a target neural network during training of the target neural network to perform one or more neural network tasks. The optimizer neural network is associated with an outer loss function that measures how well the optimizer neural network generates updated values of target parameters for the target neural network.

The system initializes current values of the optimizer parameters of the optimizer neural network (step 302).

For each truncation τ, the system repeatedly performs the following steps 304-312 to determine trained values of the optimizer parameters.

The system generates perturbed values of the optimizer parameters by applying a perturbation to the current values of the optimizer parameters (step 304).

In particular, the system samples a perturbation value e˜N(0, σ²I), where N(0, σ²I) is a Gaussian distribution with mean 0, covariance σ, and identity matrix I.

The system then generates (i) a positively-perturbed value of the optimizer parameters, denoted as θ+e, and (ii) a negatively-perturbed value of the optimizer parameters, denoted as θ−e.

The system trains an instance of target neural network to perform a target neural network task associated with the instance of target neural network by updating values of parameters of the instance of target neural network in accordance with the perturbed values of the optimizer parameters (step 306).

Specifically, the system samples a number of steps per truncation, k, for updating the values of target parameters of the target neural network, where k is a positive integer.

The system then computes a positive sequence of updated parameter values of the instance of target neural network starting from w^{(t)} by repeatedly applying (for k steps) an update rule u(⋅; θ+e) to w^{(t)}. The system 100 computes a negative sequence of updated parameter values of the instance of target neural network 120 starting from w^{(t)} by repeatedly applying (fork steps) an update rule u(⋅, θ−e) to w^{(t)}.

The system evaluates a performance of the trained instance of target neural network on the neural network task associated with the instance of target neural network to determine one or more performance metrics for the trained instance of the target neural network on the neural network task (step 308).

In particular, the system computes a pair of perturbed values for the outer loss function with both a positive and negative antithetic sample (L⁺,L⁻) using the two sequences of w from time step t to time steps t+k using either the training data or validation data associated with the neural network task.

Using the performance metrics (L⁺,L⁻) for the trained instance of the target neural network, the system computes (i) a sample of a reparameterization-based gradient estimate g^{rp} of the loss function, and (ii) a log-derivative gradient estimate g^{es} of the loss function (step 310). The system stores the sample of (g^{rp}, g^{es}) in a buffer until a batch of samples of gradients is ready, i.e., until the above process has been repeatedly performed for all truncations.

At the end of the current truncation, the system assigns the current target parameters w from one of the two sequences with the target parameter values from the end of the truncation (w^{t+k}) (step 312).

The system performs the above step 304-312 for all truncations. When the last truncation iteration is completed and the batch of samples of gradients is ready, the system computes a combined gradient estimate for the outer loss function by combining all of the samples of (θ^{rp}, g^{es}) that have been generated (step 314).

In particular, the system combines the reparameterization-based gradient estimate and the log-derivative gradient estimate based on (i) empirical variance and empirical mean of the reparameterization-based gradient estimate, and (ii) empirical variance and empirical mean of the log-derivative gradient estimate to generate the combined gradient estimate of the outer loss function. The empirical variance and empirical mean are computed based on a batch of samples of reparameterization-based gradient estimates obtained during training. The empirical variance and empirical mean are computed based on a batch of samples of log-derivative gradient estimates obtained during training.

The system adjusts the current values of the optimizer parameters of the optimizer neural network based on the combined gradient estimate of the outer loss function associated with the optimizer neural network (step 312). In particular, the system can backpropagate the combined gradient estimate of the outer loss function to adjust the current values of the optimizer parameters such that the outer loss function is minimized.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for training an optimizer neural network having optimizer parameters, wherein the optimizer neural network is configured to generate an output that defines updated values of target parameters of a target neural network during training of the target neural network to perform one or more target neural network tasks,
wherein the optimizer neural network is associated with an outer loss function that measures how well the optimizer neural network generates updated values of target parameters for the target neural network, and
wherein the method comprises:
initializing current values of the optimizer parameters;
repeatedly performing the following operations to determine trained values of the optimizer parameters:
generating perturbed values of the optimizer parameters by applying a perturbation to the current values of the optimizer parameters,
training an instance of target neural network to perform a neural network task associated with the instance of target neural network by updating values of parameters of the instance of target neural network in accordance with the perturbed values of the optimizer parameters,
evaluating a performance of the trained instance of target neural network on the neural network task associated with the instance of target neural network to determine one or more performance metrics for the trained instance of the target neural network on the neural network task,
determining, using the one or more performance metrics for the trained instances of target neural network, a gradient estimate of the outer loss function associated with the optimizer neural network, and
adjusting the current values of the optimizer parameters of the optimizer neural network based on the gradient estimate of the outer loss function associated with the optimizer neural network.

2. The method of claim 1, wherein determining the gradient estimate of the outer loss function comprises determining (i) a reparameterization-based gradient estimate of the outer loss function, and (ii) a log-derivative gradient estimate of the outer loss function.

3. The method of claim 2, wherein determining the gradient estimate of the outer loss function further comprises: determining the gradient estimate by combining the reparameterization-based gradient estimate and the log-derivative gradient estimate using an inverse variance weighting technique.

4. The method of claim 3, wherein combining the reparameterization-based gradient estimate and the log-derivative gradient estimate using an inverse variance weighting technique comprises: combining the reparameterization-based gradient estimate and the log-derivative gradient estimate based on (i) empirical variance and empirical mean of the reparameterization-based gradient estimate, wherein the empirical variance and empirical mean are computed based on a batch of observed reparameterization-based gradient estimates during training, and (ii) empirical variance and empirical mean of the log-derivative gradient estimate, wherein the empirical variance and empirical mean are computed based on a batch of observed log-derivative gradient estimates during training.

5. The method of claim 1, wherein the outer loss function is an expected training loss of the target neural network.

6. The method of claim 1, wherein the outer loss function is an expected validation loss of the target neural network.

7. The method of claim 1, wherein the outer loss function is a smoothed expected training loss of the target neural network.

8. The method of claim 1, wherein the outer loss function is a smoothed expected validation loss of the target neural network.

9. The method of claim 1, wherein evaluating the performance of the trained instance of target neural network on the neural network task associated with the instance of target neural network to determine the one or more performance metrics for the trained instance of the target neural network on the neural network task comprises: determining one or more perturbed values of the outer loss function based on the perturbed values of the optimizer parameters.

10. The method of claim 9, wherein determining the one or more perturbed values of the outer loss function comprises:
determining a positively-perturbed value of the outer loss function based on the positively-perturbed values of the optimizer parameters, wherein the positively-perturbed values of the optimizer parameters are the current values of the optimizer parameters plus the perturbation, and
determining a negatively-perturbed value of the outer loss function based on the negatively-perturbed values of the optimizer parameters, wherein the negatively-perturbed values of the optimizer parameters are the current values of the optimizer parameters minus the perturbation.

11. The method of claim 1, further comprising sampling a dataset from a set of datasets, wherein each dataset is used for training the target neural network to perform a respective neural network task, and wherein each dataset includes respective training data and respective validation data.

12. The method of claim 1, wherein generating the perturbed values of the optimizer parameters comprises sampling the perturbation from a multivariate standard normal distribution.

13. The method of claim 11, wherein repeatedly performing the following operations to determine trained values of the optimizer parameters comprise:
repeatedly performing the following operations for each of the dataset sampled from the set of datasets.

14. A system comprising one or more computers and one or more storage devices storing instructions that, when executed by the one or more computers, cause the one or more computers to perform operations of a method for training an optimizer neural network having optimizer parameters, wherein the optimizer neural network is configured to generate an output that defines updated values of target parameters of a target neural network during training of the target neural network to perform one or more target neural network tasks,
wherein the optimizer neural network is associated with an outer loss function that measures how well the optimizer neural network generates updated values of target parameters for the target neural network, and
wherein the method comprises:
initializing current values of the optimizer parameters;
repeatedly performing the following operations to determine trained values of the optimizer parameters:
generating perturbed values of the optimizer parameters by applying a perturbation to the current values of the optimizer parameters,
training an instance of target neural network to perform a neural network task associated with the instance of target neural network by updating values of parameters of the instance of target neural network in accordance with the perturbed values of the optimizer parameters,
evaluating a performance of the trained instance of target neural network on the neural network task associated with the instance of target neural network to determine one or more performance metrics for the trained instance of the target neural network on the neural network task,
determining, using the one or more performance metrics for the trained instances of target neural network, a gradient estimate of the outer loss function associated with the optimizer neural network, and
adjusting the current values of the optimizer parameters of the optimizer neural network based on the gradient estimate of the outer loss function associated with the optimizer neural network.

15. One or more non-transitory computer readable storage media encoded with instructions that, when executed by one or more computers, cause the one or more computers to perform operations of a method for training an optimizer neural network having optimizer parameters, wherein the optimizer neural network is configured to generate an output that defines updated values of target parameters of a target neural network during training of the target neural network to perform one or more target neural network tasks associated with the target neural network,
wherein the optimizer neural network is associated with an outer loss function that measures how well the optimizer neural network generates updated values of target parameters for the target neural network, and
wherein the method comprises:
initializing current values of the optimizer parameters;
repeatedly performing the following operations to determine trained values of the optimizer parameters:
generating perturbed values of the optimizer parameters by applying a perturbation to the current values of the optimizer parameters,
training an instance of target neural network to perform a neural network task associated with the instance of target neural network by updating values of parameters of the instance of target neural network in accordance with the perturbed values of the optimizer parameters,
evaluating a performance of the trained instance of target neural network on the neural network task associated with the instance of target neural network to determine one or more performance metrics for the trained instance of the target neural network on the neural network task,
determining, using the one or more performance metrics for the trained instances of target neural network, a gradient estimate of the outer loss function associated with the optimizer neural network, and
adjusting the current values of the optimizer parameters of the optimizer neural network based on the gradient estimate of the outer loss function associated with the optimizer neural network.
